(19) United States
(12) Patent Application Publication
(10) Pub. No.: US 2026/0158444 A1
(43) Pub. Date: Jun. 11, 2026

(54) METHOD OF MANUFACTURING A SUPPORT PIN

(71) Applicant: Eichenauer GmbH & Co. KG, Kandel (DE)

(72) Inventors: Mike Gensheimer, Rohrbach (DE); Ingo Liedtke, Minfeld (DE); Andreas Klein, Billigheim-Ingenheim (DE); Meike Kämmerer, Walsheim (DE)

(73) Assignee: Eichenauer GmbH & Co. KG, Kandel (DE)

(21) Appl. No.: 19/052,278

(22) Filed: Feb. 13, 2025

(30) Foreign Application Priority Data
Feb. 13, 2024 (DE) 10 2024 103 934.5

(51) Int. Cl. B01D 53/86; B32B 1/00; B32B 5/16; B32B 15/04; C01F 5/02

(52) U.S. Cl. CPC B01D 53/86; B32B 1/00; B32B 5/16; B32B 15/04; C01F 5/02; B32B 2264/102; B32B 2264/303; B32B 2307/304; C01P 2004/60

(57) ABSTRACT

A method is described for producing a support pin which has a sleeve made of metal, a pin body made of metal and surrounded by the sleeve, and an insulator which fills an annular gap between the pin body and the sleeve. The pin body is arranged in the sleeve. Then a part of the annular gap is filled with insulator powder and the insulator powder is compressed in the axial direction of the sleeve. Then a further part of the annular gap is filled with insulator powder and the insulator powder is compressed in the axial direction. A support pin produced in this way is also described.

### CROSS-REFERENCE TO RELATED APPLICATIONS

This application claims priority to German Patent Application No. DE 10 2024 103 934.5 filed on Feb. 13, 2024, the entire contents of which are hereby incorporated in full by this reference.

### DESCRIPTION

### Field of the Invention

The invention relates to a support pin, in particular for supporting an electrical heating element on a supporting body of a catalytic converter. Support pins are known, for example, from DE 10 2018 213 358 A1 and DE 100 55 447 B4.

### Background of the Invention

Such support pins comprise a metallic sleeve, a metallic pin body surrounded by the sleeve, and an insulator that mechanically stabilizes the pin body and electrically insulates it from the sleeve, i.e. fills an annular gap between the pin body and the sleeve. For reliable function, it is important that the insulator is as well compacted as possible, i.e. that unfilled cavities are avoided as far as possible.

One way of producing support pins, described in DE 100 55 447 B4, is to arrange a wire in a tube filled with ceramic powder, then reduce the diameter of the tube by hammering, thereby compacting the powder. The tube is then cut into pieces of the desired length. It is also known from DE 100 55 447 B4 to arrange a pin body in a metallic half-shell filled with pourable or flowable insulator material and then to reduce the size of the half-shell in order to compact the insulator material. In this way, a good density of the insulator is also achieved. One disadvantage of both methods, however, is the effort involved in shaping the pipe or half-shell.

DE 10 2018 213 358 A1 discloses the use of a ceramic insulator sleeve instead of powdered or pasty insulator material. This insulator sleeve is then inserted into the metallic sleeve as an inner sleeve. In this way, the effort associated with deforming the sleeve is avoided, but dimensionally accurate production of a ceramic inner sleeve is complex and therefore an air gap between the pin body and ceramic sleeve or ceramic sleeve and metallic sleeve is difficult to avoid.

An object of the present invention is therefore to show a way of producing a support pin at low cost, the insulator of which has a good density.

### SUMMARY OF THE INVENTION

This object is achieved by a method for manufacturing a support pin according to claim 1. The invention also relates to a support pin manufactured using such a method. Advantageous refinements of the invention are the subject of dependent claims.

In a method according to the invention, the pin body is first arranged in the sleeve and then insulator powder is filled into the annular space between the pin body and the sleeve in several steps. After each step, the insulator powder is axially pressed into the annular space, for example with a hollow cylindrical punch which is pressed into the annular space. In this way, an insulator with a very good density can be produced, which fills the annular space between the pin body and sleeve well without the sleeve having to be deformed.

When pressing bulk or granular materials, the force exerted on a surface decreases sharply with increasing distance. In the context of the invention, it was recognized that despite this general property of bulk materials and powders, good compaction can still be achieved by filling only part of the annular space with powder before each pressing operation and consequently the pressure exerted in the powder during a pressing operation has to be transmitted only over a small distance in the axial direction. In an embodiment of the invention, insulator powder is filled into the annular gap two to ten times and pressed in the axial direction before further insulator powder is filled in. For example, three to six times.

The insulator powder used may be broken ceramic, for example, or powder in the narrower sense with grain sizes of 25 μm to 500 μm, for example.

An advantageous refinement of the invention provides that ceramic powder, for example magnesium oxide, is used as insulator powder.

### BRIEF DESCRIPTION OF THE DRAWINGS

Further details and advantages of the invention are explained with reference to the attached illustrations.

FIG. 1 shows a schematic representation of a method for manufacturing a support pin,

FIG. 2 shows a schematic representation of an embodiment of a support pin,

FIG. 3 shows a sectional view along the sectional line AA of FIG. 2,

FIG. 4 shows a further sectional view along the sectional line BB of FIG. 3, and

FIG. 5 shows photographs of a support pin cut open.

### DETAILED DESCRIPTION OF EMBODIMENTS OF THE INVENTION

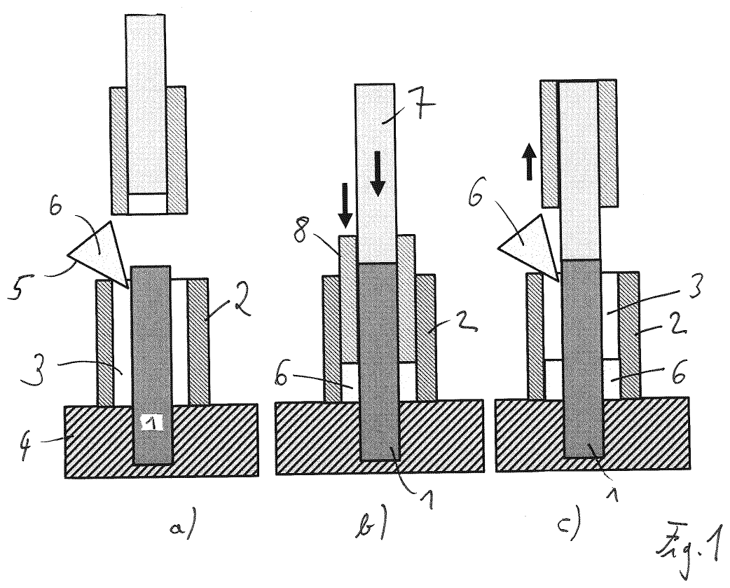

FIG. 1 schematically shows the sequence of steps of a method for manufacturing a support pin. In step a), a metal pin body 1 is arranged centrally in a metal sleeve 2 on a base 4 of a tool and part of the annular gap 3 between pin body 1 and sleeve 2 is filled with insulator powder, for example magnesium oxide. Shown schematically is a container 5 from which the insulator powder 6 is poured into the annular gap 3.

In step b), part of the annular gap is already filled with insulator powder 6. The pin body 1 is then fixed by a hold-down device 7, i.e., movement relative to the sleeve 2 is prevented, and the insulator powder 6 is pressed into the annular gap in the axial direction, for example by means of a hollow cylindrical punch 8, which is pressed into the annular gap. The axial direction runs in the longitudinal direction of the pin body 1.

In step c), a further part of the annular gap 3 is filled with insulator powder 6. This is followed by pressing steps according to b) and further steps in which a further part of the annular gap 3 is filled according to step a) and then pressed according to step b) until the annular gap 3 is completely filled with pressed insulator powder 6.

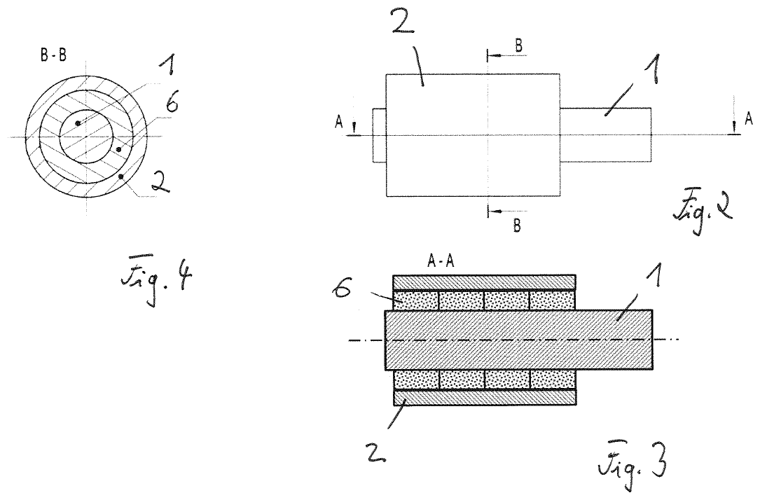

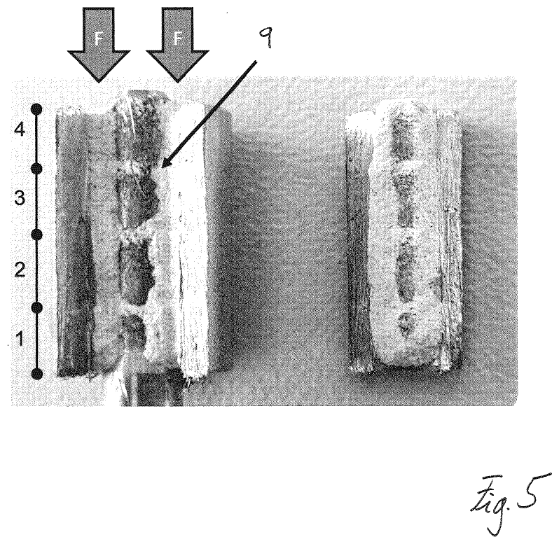

A support pin manufactured in this way, which is provided, for example, as an electrical feedthrough for an exhaust gas purification catalytic converter, is shown schematically in FIG. 2. FIG. 3 shows a longitudinal section of the pin along section line AA of FIG. 2 and FIG. 4 shows a cross-section along section line BB.

In the example shown, both ends of the pin body 1 protrude from the sleeve 2. In this way, the support pin can also be used advantageously as an electrical feed-through and for electrical contacting. However, it is also possible for one or even both ends of the pin body 1 to end flush with the sleeve 2 or even in the sleeve 2.

The pin body 1 is surrounded in the sleeve 2 by pressed insulator powder 6. In the example shown, insulator powder was filled four times into the annular gap between pin body 1 and sleeve 2 and pressed axially. FIG. 3 therefore schematically shows four layers of pressed insulator powder 6.

The number of layers can be varied according to the length of the sleeve 2. In general, three to ten layers, in particular, four to eight layers, of pressed insulator powder 6 are advantageous.

FIG. 5 shows a photograph of a cut-open support pin. This clearly shows that the pressed insulator powder 6 forms layers 1 to 4 and adheres particularly well to the pin body 1 in ring-shaped areas, meaning that the layers shown schematically in FIG. 3 or the boundary areas 9 between them can be recognized.

### LIST OF REFERENCE SYMBOLS

1 Pin body
2 Sleeve
3 Annular gap
4 Base
5 Container
6 Insulator powder
7 Hold-down device
8 Punch
9 Boundary area

What is claimed is:

1. A method of manufacturing a support pin comprising a sleeve of metal, a pin body of metal surrounded by the sleeve and an insulator which fills an annular gap between the pin body and the sleeve, the method comprising the steps of:
arranging the pin body in the sleeve,
then filling a part of the annular gap with insulator powder and compressing the insulator powder in an axial direction of the sleeve; and
then filling a further part of the annular gap with insulator powder and compressing the insulator powder in the axial direction.

2. The method according to claim 1, wherein insulator powder is filled into the annular gap two to ten times and compressed in the axial direction before further insulator powder is filled in.

3. The method according to claim 1, wherein the pin body is fixed relative to the sleeve when the insulator powder is compressed.

4. The method according to claim 1, wherein the insulator powder is compressed with a hollow cylindrical punch, which is pressed into the annular gap.

5. The method according to claim 1, wherein the insulator powder is magnesium oxide.

6. The method according to claim 1, wherein at least 95% by weight of the insulator powder consists of grains which pass through sieve openings of 180 μm in a sieve analysis.

7. The method according to claim 1, wherein at least 75% by weight of the insulator powder consists of grains which pass through sieve openings of 150 μm in a sieve analysis.

8. The method according to claim 1, wherein at least 80 % by weight of the insulator powder consists of grains which do not pass through sieve openings of 45 μm in a sieve analysis.

9. The method according to claim 1, wherein fracture ceramics are used as insulator powder.

10. The support pin, comprising:
the sleeve made of metal;
the metal pin body surrounded by the sleeve; and
the insulator which fills the annular gap between the pin body and the sleeve;
wherein the support pin was manufactured using the method according to claim 1.
